(19) United States
(12) Patent Application Publication
(10) Pub. No.: US 2005/0142399 A1
(43) Pub. Date: Jun. 30, 2005

(54) Procedure for starting up a fuel cell using a fuel purge

(76) Inventors: Galen W. Kulp, Vernon, CT (US); Richard D. Breault, North Kingstown, RI (US)

Correspondence Address: Malcolm J. Chisholm, Jr., P.O. Box 278, 220 Main Street, Lee, MA, 01238, US

(21) Appl. No.: 10/749,971

(22) Filed: Dec. 31, 2003

(51) Int. Cl. H01M 8/00; H01M 8/04

(52) U.S. Cl. 429/13; 429/34; 429/26

(57) ABSTRACT

A vacuum fuel cell system (10) and procedure provide for starting up a fuel cell (12) with a rapid fuel purge of an anode flow field (38) to minimize corrosion of a carbon catalyst support layer (26) by a reverse current mechanism produced by movement of a fuel-air front through the anode flow field (38). A vacuum source (90) applies a vacuum to the anode flow field (38) while the fuel cell (12) is shut down and while a fuel inlet valve (70) and a fuel exhaust valve (74) are closed. The resulting vacuum within the anode flow field (38) produces rapid purge of the fuel through the anode flow field (38) upon start up, and a strong vacuum will get rid of essentially all of the air within the anode flow field (38) to virtually eliminate movement of the fuel-air front.

### TECHNICAL FIELD

The present invention relates to fuel cells that are suited for usage in transportation vehicles, portable power plants, or as stationary power plants, and the invention especially relates to a system and procedure that minimizes performance degradation of fuel cells resulting from starting up the fuel cells.

### BACKGROUND ART

Fuel cells are well known and are commonly used to produce electrical energy from hydrogen containing reducing fluid and oxygen containing oxidant reactant streams to power electrical apparatus such as motors, and transportation vehicles, etc. In fuel cells of the prior art, it has been discovered that, upon start up of fuel cells, corrosion takes place on catalyst layers of electrodes, and especially on cathode catalyst layers. That corrosion leads to performance loss of the cathode catalyst layers and the fuel cells.

In starting up known fuel cells that contain air on both anode and cathode catalyst layers and that employ a proton exchange membrane “PEM” as an electrolyte disposed between a cathode and anode catalyst layer, an oxygen containing oxidant is directed to flow through a cathode flow field that directs the oxidant to flow adjacent to the cathode catalyst layer. At about the same time a hydrogen rich reducing fluid fuel stream is directed to flow through an anode flow field that directs the fuel to flow adjacent the anode catalyst layer. As the fuel flows through the anode flow field, a fuel-air front is created moving along the anode catalyst layer until the fuel forces all of the air out of the anode flow field. It has been observed that catalyst layers that are opposite the fuel-air front experience substantial corrosion with each start up of known fuel cells. This problem has come to be characterized as a result of a “reverse current mechanism” resulting from the advance of the fuel-air front through the flow field, which is described in more detail in commonly owned U.S. patent application Ser. No. 10/305,301 that has been published under Publication No. U.S. 2002/0134165 A1.

It is known that purging the anode and cathode flow fields with inert gases immediately upon shut down of the fuel cell passivates the anode and cathode catalyst layers to minimize such oxidative decay. For example, commonly owned U.S. Pat. Nos. 5,013,617 and 5,045,414 describe using 100% nitrogen as the anode side purge gas, and a cathode side purging mixture comprising a very small percentage of oxygen (e.g. less than 1%) with a balance of nitrogen. Both of these patents also discuss the option of connecting a dummy electrical load across the cell during the start of a purging process to lower the cathode potential rapidly to between the acceptable limits of 0.3-0.7 volt. However, the costs and complexity of such stored inert gases are undesirable especially in automotive applications where compactness and low cost are critical, and where the system must be shut down and started up frequently.

Known improvements to the problem of oxidation and corrosion of electrode catalysts and catalyst support materials have reduced the deleterious consequences of the presence of oxygen on the cathode electrode and a non-equilibrium of reactant fluids between the anode and cathode electrodes that result in unacceptable anode and cathode electrode potentials upon and during shut down and start up of a fuel cell. However, it has been found that even with known solutions, the presence of any oxygen within an anode flow field during start up results in a reverse current leading to unacceptable, localized electrode potentials and corrosion of catalysts and catalyst support materials.

Consequently, there is a need for a procedure for starting up a fuel cell that minimizes oxidation and corrosion within the fuel cell.

### DISCLOSURE OF INVENTION

The invention is a procedure for starting up a fuel cell with a fuel purge using a vacuum to reduce or eliminate oxygen within the shut down fuel cell prior to purging the cell with fuel. The fuel cell includes a cathode secured adjacent one side of an electrolyte layer of the cell and an anode secured adjacent an opposed side of the electrolyte layer, wherein the cathode includes a catalyst supported on carbon. The fuel cell also includes a cathode flow field defined adjacent the cathode and an anode flow field defined adjacent the anode for directing the oxygen containing oxidant and reducing fluid fuel reactant streams to flow through the fuel cell. During shut down of the fuel cell, both the cathode and anode flow fields are filled with air, and the primary electricity using device or load is disconnected from the fuel cell. The procedure includes the steps: of applying a vacuum to the anode flow field; then delivering a continuous flow of fresh hydrogen containing fuel into the anode flow field; then delivering a flow of oxidant to the cathode flow field; and, then connecting the primary load to the fuel cell. The procedure is repeated each time the fuel cell is started up. In an alternative embodiment, a vacuum may also be applied to the cathode flow field.

The invention also includes a vacuum fuel cell system for starting up a fuel cell that includes a vacuum source such as a vacuum pump secured in fluid communication with the anode flow field, and in an alternative embodiment, the vacuum pump is also secured in fluid communication with the cathode flow field. The vacuum system also includes valves for controlling flow of the fuel and oxidant streams into and through the fuel cell as well as valves for controlling application of the vacuum to the fuel cell.

In a preferred embodiment, the fuel cell may include a porous water transport plate, that is also known as a cooler plate, for directing flow of a cooling liquid through the fuel cell. Where the water transport plate is a porous plate secured in fluid communication with the anode flow field, the vacuum pump may also apply a vacuum to a coolant accumulator in fluid communication with the cooling fluid in order to minimize a pressure differential across the porous water transport plate while the vacuum is being applied to the anode flow field. The invention includes applying a vacuum to the anode and/or cathode flow field that results in a pressure differential between the flow fields and the cooling fluid that is not greater than a bubble pressure of the porous water transport plate.

The vacuum level applied to the anode and/or cathode flow field may range from 21 kilo Pascals (“kPa”) (about 3 pounds per square inch (“psi”) to about 95 kPa (about 13.5 psi) below ambient pressure. A fuel inlet pressure of about 10.5 kPa (about 1.5,psi) above ambient pressure results in a pressure differential between the entering fuel and the anode flow field of between about 31.5 kPa (4.6 psi) to about 105.5 kPa (15 psi). Such an enhanced pressure differential greatly decreases an amount of time necessary for the hydrogen fuel to pass through the anode flow field, thereby decreasing oxidation and corrosion resulting from the reverse current mechanism associated with movement of the fuel-air front. More importantly, the vacuum may remove virtually all of the air within the anode and/or cathode flow fields. Removal of the air from the anode flow field essentially eliminates the reverse current mechanism that creates the corrosion.

Accordingly, it is a general purpose of the present invention to provide a procedure for starting up a fuel cell using a fuel purge that overcomes deficiencies of the prior art.

It is a more specific purpose to provide a procedure for starting up a fuel cell using a fuel purge that minimizes oxidation and corrosion of catalyst support materials.

These and other purposes and advantages of the present procedure for starting up a fuel cell using a fuel purge will become more readily apparent when the following description is read in conjunction with the accompanying drawing.

### BRIEF DESCRIPTION OF THE DRAWING

FIG. 1 is a simplified schematic representation of a preferred embodiment of a vacuum fuel cell system capable of performing the procedure for starting up a fuel cell using a fuel purge in accordance with the present invention.

### DESCRIPTION OF THE PREFERRED EMBODIMENTS

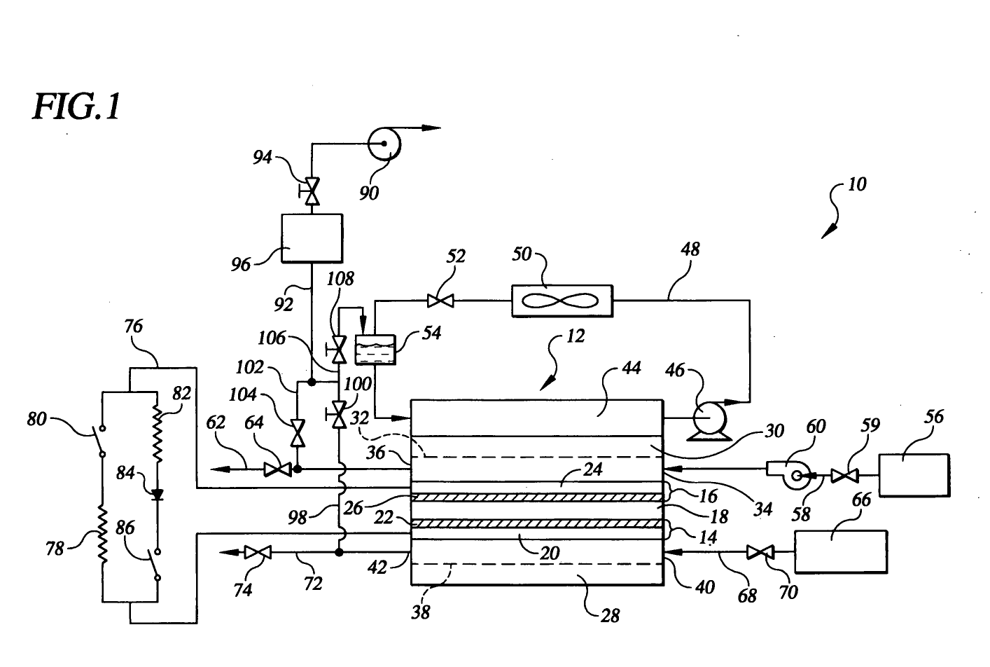

Referring to the drawings in detail, a vacuum fuel cell system is shown in FIG. 1, and is generally designated by the reference numeral 10. The system includes a fuel cell 12 having an anode 14 a cathode 16 secured to opposed sides of an electrolyte layer 18. The anode includes an anode substrate 20 having an anode catalyst layer 22 disposed on the substrate 20 on a side adjacent the electrolyte layer 18. Similarly, the cathode 16 includes a cathode substrate 24 having a cathode catalyst supported on a carbon support 26 disposed on the substrate on a side adjacent the electrolyte layer 18. The fuel cell 12 also includes an anode flow field plate 28 adjacent the anode substrate 20 and a cathode flow field plate 30 adjacent the cathode substrate 24.

The cathode flow field plate 30 defines a plurality of oxidant channels 32 extending across the plate 30 forming a cathode flow field for directing flow of an oxygen containing oxidant, such as air, across the cathode flow field plat 20 from an oxidant inlet 34 to an oxidant outlet 36. The anode flow field plate 28 also has a plurality of fuel channels 38 extending across the plate 28 forming an anode flow field for directing flow of a hydrogen containing reducing fluid fuel from a fuel inlet 40 to a fuel outlet 42.

The fuel cell 12 may also include a cooler plate 44 secured adjacent the cathode flow field plate 20. The cooler plate 44 may be either a solid plate for removing heat from the cell 12, or may be a porous plate known in the art for removing heat and fuel cell 12 product water as well as providing for humidification of reactant streams, etc. A coolant pump 46 may be secured to a coolant loop 48 for passing a liquid coolant such as water or an antifreeze solution through the cooler plate 44, a radiator 50, a flow control or pressure control valve 52 and a coolant accumulator 54 so that the liquid coolant circulates through the cooler plate 44. It should be understood that the vacuum fuel cell system 10 would include a plurality of fuel cell similar to the described fuel cell 12 cooperatively arranged in a fuel cell stack assembly well known in the art. In such a cell stack assembly, an additional cooler plate (not shown) would be secured adjacent the anode flow field plate 28 and would receive flow of the liquid coolant from the coolant loop 48, as is well known. Therefore, the discussion herein will assume that the cooler plate 44 is a water transport plate and is in direct fluid communication with the anode flow field 38 for purposes of efficiency of description of the relationship between the pressure differential between the liquid coolant within the coolant loop and the anode flow field 38.

The vacuum fuel cell system 10 also includes an oxidant source 56 in fluid communication with an oxidant inlet line 58 having a oxidant inlet valve 59 and possibly an oxidant blower 60 secured to the line 58 for directing the oxidant reactant stream into and through the cathode flow field 32. An oxidant exhaust line 62 and an oxidant exhaust valve 64 are also secured in fluid communication with the cathode flow field 32 in a manner known in the art for selectively directing the oxidant out of the fuel cell 12. The system 10 also includes a fuel source 66 secured in fluid communication through a fuel inlet line 68 having a fuel inlet valve 70 with the anode flow field 38. A fuel exhaust line 72 and fuel exhaust valve 74 are also secured in fluid communication with the anode flow field 38 to selectively direct the fuel out of the fuel cell 12.

As reactant streams are controlled to flow through the fuel cell 12, electricity is produced in a manner well known in the art and the electricity is directed through a power circuit 76 to a primary load 78, such as a motor to power an automobile, through a primary load switch 80. An auxiliary load 82 may be secured across the power circuit, as shown schematically in FIG. 1, including a diode 84 between the auxiliary load 82 and an auxiliary load switch 86, for lowering the cell voltage from its open circuit voltage of about 0.90-1.0 volts per cell to about 0.20 volts per cell or less, as is known in the art.

The vacuum fuel cell system 10 also includes a vacuum source means for selectively applying a vacuum to the anode flow field 38 and the cathode flow field 32. By the phrase “selectively applying”, it is meant that the vacuum may be applied at a predetermined level for a predetermined duration at a predetermined time, such as just prior to directing flow of the fuel reactant stream into the anode flow field 38. The vacuum source means may be a traditional vacuum pump known in the art or any other apparatus known in the art that is capable of generating a vacuum within the anode flow field 38 and cathode flow field 32. The vacuum pump 90 may be in fluid communication through a vacuum draw line 92 and pump valve 94 with a vacuum receiver 96 for enhancing efficiency of the vacuum pump 90 by permitting a relatively long generation of a vacuum within the receiver 96 by a relatively small pump 90, so that the receiver may thereafter rapidly apply the vacuum to the flow fields 38, 32.

An anode vacuum draw line 98 and anode vacuum valve 100 are secured in fluid communication between the anode flow field 38 and the vacuum pump 90 for selectively permitting the vacuum force to draw on the anode flow field 38. A cathode vacuum draw line 102 and cathode vacuum valve 104 are also secured in fluid communication with the vacuum pump 90 for selectively permitting the vacuum force to draw on the cathode flow field 32. If the cooler plate 44 of the vacuum fuel cell system 10 is a porous water transport plate 44, a coolant loop vacuum draw line 106 and coolant loop vacuum valve 108 may also be secured in fluid communication between the vacuum pump 90 and the coolant accumulator 54. If the cooler plate 44 is solid, then there would be no coolant loop draw line 106.

In operation of the vacuum fuel cell system 10, as the fuel cell 12 is generating electricity to power the primary load 78, the vacuum pump 90 is not operating and the anode vacuum valve 100, cathode vacuum valve 104 and any coolant loop vacuum valve 108 are closed so that no fluids pass through them. The fuel cell 12 is shut down in a manner known in the art, as for example disclosed in commonly owned U.S. Pat. No. 6,635,370. As described therein, the fuel cell 12 is shut down essentially as follows: the primary load is removed by opening the primary load switch 80 (as shown in FIG. 1.); the flow of oxidant through the cathode flow field 32 is then discontinued by closing the oxidant inlet and exhaust valves 59, 64; the auxiliary load 82 is connected by closing the auxiliary load switch 86 to consume oxygen in the cathode flow field 32; and, the fuel flow is then discontinued by closing the fuel inlet and exhaust valves 70, 74, while the auxiliary load preferably remains connected during shut down of the vacuum fuel cell system 10.

By the procedure of the present invention, in starting up the fuel cell 12, the aforesaid oxidant and fuel inlet and exhaust valves 59, 64, 70, 74 remain closed. In a first embodiment of the procedure, a vacuum is applied to the anode flow field 38 by operating the vacuum pump 90 and opening the anode vacuum valve 100 until a predetermined vacuum level is achieved within the anode flow field 38. Then, the anode vacuum valve 100 is closed and the vacuum pump 90 is stopped. Next, the fuel inlet valve 70 and fuel exhaust valve 74 are opened to permit a rapid flow or purge of fuel through the anode flow field 38. Then, the auxiliary load 82 is disconnected; the oxidant inlet and exhaust valves 59, 64 are opened to permit flow of the oxidant through the cathode flow field 32, while any oxidant blower 60 is operated; and then the primary load 78 is connected. The coolant pump 46 would be operated as or shortly after the primary load is connected. If the cooler plate 44 is a porous water transport plate 44, then the coolant pump 46 will be operated prior to the introduction of the hydrogen fuel to the anode flow field 38.

If the cooler plate 44 is a porous water transport plate 44 in direct fluid communication with the anode flow field 38, while the vacuum is being applied to the anode flow field 38, the coolant loop vacuum valve 108 is opened to permit a vacuum to be drawn within the coolant accumulator 54. That effectively decreases any pressure differential between the liquid coolant within the water transport plate 44 and the pressure within the anode flow field 38, thereby permitting a greater overall vacuum to be applied to the anode flow field 38 without exceeding a bubble pressure of the water transport plate 44 and drawing any liquid coolant into the anode flow field 38. In an alternative embodiment, a vacuum may also be applied to the cathode flow field by opening the cathode vacuum valve 104.

By applying a vacuum to the anode flow field 38, the rate of movement of any fuel-air front through the anode flow field is significantly enhanced, which effectively minimizes the reverse current mechanism that leads to oxidation and corrosion of the carbon support of the cathode catalyst layer 26 and anode catalyst layer 22. More importantly, if the vacuum is at a sufficient level to remove virtually all of the air within the anode flow field 38 prior to introduction of the hydrogen fuel, then there is virtually no fuel-air front moving through the anode flow field 38, which even further minimizes any oxidation or corrosion of the carbon in the catalyst layers 22, 26. By applying a vacuum to both the anode flow field 38 and also to the cathode flow field 32, more air is removed which further minimizes the occurrence of any possible reverse current mechanism.

It has been determined that the vacuum level applied to the anode and/or cathode flow field may range from 21 kilo Pascals (“kPa”) (about 3 pounds per square inch (“psi”) to about 95 kPa (about 13.5 psi) below ambient pressure. A fuel inlet pressure of about 10.5 kPa (about 1.5 psi) above ambient pressure is typical and results in a pressure differential between the entering fuel and the anode flow field of between about 31.5 kPa (4.6 psi) to about 105.5 kPa (15 psi). The vacuum level is set by the boiling point of water. The vacuum pump 90 should be capable of drawing a vacuum equal to or greater than the vapor pressure of water at twenty degrees centigrade.

Data has been established and presented in the following TABLE 1 by the inventors of the present invention regarding the effects of varying vacuums applied to the anode flow field 38. Table 1 shows the absolute pressure at the fuel inlet 40, a typical pressure drop, for nominal flow rates, across the anode flow field 38 expressed as a pressure differential, the absolute pressure within the anode flow field 38 after the vacuum is applied and before the hydrogen fuel purge is initiated, and an estimate of the time for the hydrogen front to pass through the anode flow field.

TABLE 1

| | | | Anode Flow | Time for |
|---|---|---|---|---|
| | | | Field Pressure | Hydrogen |
| Fuel | | | Before | Front to |
| Inlet | Pressure | Pressure | Hydrogen | Pass Through |
| Pressure | Drop | Drop | Purge | Flow Field |
| kPa | psi | kPa | kPa | Seconds |
| 111.7 | 1.5 | 10.3 | 101.3 | 0.41 |
| 111.7 | 4.5 | 31.0 | 80.6 | 0.14 |
| 111.7 | 7.5 | 51.7 | 60 | 0.09 |
| 111.7 | 10.5 | 72.4 | 39.3 | 0.06 |
| 111.7 | 16.2 | 111.7 | 0 | 0.04 |

As is apparent, achieving a pressure differential of approximately 111.7 kPa between the hydrogen fuel entering the anode flow field 38 and the initial pressure within the anode flow field 38 significantly decreases the time required for the hydrogen to pass through the anode flow field 38. However, it is stressed again that the benefit achieved in decreased corrosion is significantly greater than a direct comparison to corrosion rates at the slower times to pass through the anode flow field 38. That is because at the higher vacuum levels, there is virtually no air remaining within the anode flow field 38, and hence the reverse current mechanism cannot take place resulting in virtually no oxidation or corrosion. The fuel cell 12 and any fuel cell stack of the vacuum fuel cell system 10 must be designed with adequate mechanical integrity to withstand the described pressure differentials. The operation of the present vacuum fuel cell system 10 would be facilitated by controllers and sensors known in the fuel cell art, as fore example described in the Patents referred to above. For purposes herein, the word “about” means plus or minus 10 per cent.

All of the aforementioned U.S. Patents and U.S. Patent Application are incorporated herein by reference.

While the present invention has been disclosed with respect to the described and illustrated embodiments of a procedure and system for starting up a fuel cell with a fuel purge, it is to be understood that the invention is not to be limited to those embodiments. Accordingly, reference should be made primarily to the following claims rather than the foregoing description to determine the scope of the invention.

1. A procedure for starting up a vacuum fuel cell system (10), the system including at least one fuel cell (12) having a cathode (16) secured adjacent one side of an electrolyte layer (18), an anode (14) secured adjacent an opposed side of the electrolyte layer (18), wherein the cathode (16) includes a cathode catalyst supported on a carbon support (26), a cathode flow field (32) defined adjacent the cathode (16) and an anode flow field (38) defined adjacent the anode (14), wherein both the cathode and anode flow fields (32, 38) are filled with air and a primary electricity using device (78) is disconnected from the fuel cell (12) power circuit (76) during a shut down of the fuel cell (12), the procedure comprising the steps of:
a. applying a vacuum to the anode flow field (38);
b. then, delivering a continuous flow of hydrogen fuel into the anode flow field (38);
c. then delivering a flow of oxidant into the cathode flow field (32); and,
d. then connecting the primary load to the fuel cell (12) power circuit (76).

2. The procedure of claim 1, wherein the step of applying the vacuum to the anode flow field (38) includes applying a vacuum until an absolute pressure within the anode flow field (38) is between about 60 kPa to about 85 kPa.

3. The procedure of claim 1, wherein the step of applying the vacuum further comprises applying a vacuum to the cathode flow field (32).

4. The procedure of claim 3, wherein the step of applying the vacuum to the cathode flow field (32) includes applying a vacuum until an absolute pressure within the cathode flow field (32) is between about 5 kPa to about 15 kPa.

5. The procedure of claim 1 wherein the step of applying the vacuum to the anode flow field (38) includes applying a vacuum until an absolute pressure within the anode flow field (38) is between about 5 kPa to about 15 kPa.

6. The procedure of claim 1, wherein the vacuum fuel cell system (10) includes a porous water transport plate (44) secured in direct fluid communication with the anode flow field (38) for directing a liquid coolant to pass through the water transport plate (44) and through a coolant accumulator (54), wherein the step of applying a vacuum to the anode flow field (38) further comprises applying a vacuum to the coolant accumulator (54) so that the vacuum level applied to the anode flow field (38) is about the same as the vacuum level applied to the coolant accumulator (54).

7. The procedure of claim 1, comprising the further steps of connecting an auxiliary load (82) to the fuel cell (12) power circuit (76) prior to the step of delivering the continuous flow of hydrogen fuel, and disconnecting the auxiliary load (82) from the fuel cell (12) power circuit (76) prior to the step of delivering a flow of oxidant into the cathode flow field (32).

8. A vacuum fuel system (10) for starting up a fuel cell (12), comprising:
a. at least one fuel cell (12) having a cathode (16) secured adjacent one side of an electrolyte layer (18), an anode (14) secured adjacent an opposed side of the electrolyte layer (18), wherein the cathode (16) includes a cathode catalyst supported on a carbon support (26), a cathode flow field (32) defined adjacent the cathode (16) for directing an oxygen containing oxidant to flow adjacent the cathode (16) and an anode flow field (38) defined adjacent the anode (14) for directing a hydrogen containing reducing fluid to flow adjacent the anode (14);
b. an oxidant inlet valve (59) and an oxidant exhaust valve (64) secured in fluid communication with the cathode flow field (32) for permitting and prohibiting flow of the oxidant through the cathode flow field (32), a fuel inlet valve (70) and a fuel outlet valve (74) secured in fluid communication with the anode flow field (38) for permitting and prohibiting flow of the fuel through the anode flow field (32); and,
c. a vacuum source means (90) secured in fluid communication with the anode flow field (38) for selectively applying a vacuum to the anode flow field (38) when the fuel inlet valve (70) and fuel exhaust valve (74) are closed to prohibit flow of the fuel through the anode flow field (38).

9. The vacuum fuel cell system (10) of claim 8, wherein the vacuum source means is also secured in fluid communication with the cathode flow field (32) for selectively applying a vacuum when the oxidant inlet valve (59) and oxidant exhaust valve (64) are closed to prohibit flow of the oxidant through the cathode flow field (32).

10. The vacuum fuel cell system (10) of claim 8, further comprising a porous water transport plate (44) secured in direct fluid communication with the anode flow field (38) for directing a liquid coolant to pass through the water transport plate (44) and through a coolant accumulator (54), and wherein the vacuum source means (90) is secured in fluid communication with the coolant accumulator (54) for selectively applying a vacuum to the coolant accumulator (54) so that the vacuum applied to the anode flow field (38) is about the same as the vacuum applied to the coolant accumulator (54).

11. The vacuum fuel cell system (10) of claim 8, further comprising an auxiliary load (82) secured in electrical communication with a fuel cell (12) power circuit (76) for selectively controlling fuel cell voltage.
